(19) United States
(12) Patent Application Publication
(10) Pub. No.: US 2007/0263654 A1
(43) Pub. Date: Nov. 15, 2007

(54) Pro-active congestion mitigation for wireless networks

(75) Inventors: Juha Salokannel, Tampere (FI); He Xiaoben, Helsinki (FI); Jarkko Kneckt, Espoo (FI)

Correspondence Address: Brake Hughes PLC;C/O Intellevate, P.O. Box 52050, Minneapolis, MN, 55402, US

(73) Assignee: Nokia Corporation

(21) Appl. No.: 11/433,862

(22) Filed: May 12, 2006

(51) Int. Cl. H04L 12/26; H04L 12/413

(52) U.S. Cl. 370/448; 370/229

(57) ABSTRACT

Various embodiments are disclosed relating to pro-active congestion mitigation in wireless networks. In an example embodiment, a wireless node may make a determination that an amount of previous channel usage by the wireless node is greater than a threshold value, and then delay an acquisition of a transmission opportunity based on the determination. For example, the wireless node may delay a start of a backoff time counter based on the determination, and/or may increase a value of the backoff time counter based on the determination.

### BACKGROUND

The rapid diffusion of Wireless Local Area Network (WLAN) access and the increasing demand for WLAN coverage is driving the installation of a very large number of Access Points (AP). The most common WLAN technology is described in the Institute of Electrical and Electronics Engineers IEEE 802.11 family of industry specifications, such as specifications for IEEE 802.11b, IEEE 802.11g and IEEE 802.11a. Other wireless technologies are being developed, such as IEEE 802.16 or WiMAX technology. A number of different 802.11 task groups are involved in developing specifications relating to improvements to the existing 802.11 technology. A draft specification from the IEEE 802.11e Task Group has proposed a set of QoS parameters to be used for traffic between an Access Point and a station. See, e.g., Tim Godfrey, “Inside 802.11e: Making QoS A Reality Over WLAN Connections,” CommsDesign, Dec. 19, 2003. Similarly in Ultra Wideband (UWB) environment, the WiMedia Alliance has published a draft standard, “Distributed Medium Access Control (MAC) for Wireless Networks,” Release 1.0, Dec. 8, 2005. These are a few examples of wireless network specifications, and there are many other technologies and standards being developed.

A number of wireless standards allow stations to access a channel through a contention based channel access mechanism, where wireless nodes may contend for channel access. For example, in WiMedia Distributed MAC specification, this channel access technique is referred to as prioritized contention access (PCA), where contention access is provided using different access categories (ACs), or traffic priorities. For example, for WiMedia and for 802.11e Enhanced Data Channel Access (EDCA), different quality of service (QoS) parameters may be provided for each AC. For example, QoS parameters may include: CWmin[AC], which is the minimum contention window for the AC, the CWmax[AC], the AIFSN[AC] which is the arbitration inter-frame spacing for the AC, the TXOPLimit[AC] which defines the length of the transmission opportunity or TXOP a wireless node is granted. Values for these parameters may be established to favor higher ACs or over lower ACs, for example.

A problem may arise in some cases where one wireless node may consume a significant percentage of channel usage, thereby preventing other nodes, e.g., even nodes having a same AC, from obtaining channel access. As an example, in some cases, access to the channel may be determined as a race between nodes. For example, nodes that may already be connected to the channel, in some cases, may have a better chance of winning a transmission opportunity (TXOP) because of the unfairness of the EDCA channel access protocol. It may therefore be desirable to provide a technique to improve fairness in contention based channel access for wireless networks.

### SUMMARY

Various embodiments are disclosed relating wireless networks, and also relating to pro-active congestion mitigation in a wireless network.

In an example embodiment, a wireless node may make a determination that an amount of previous channel usage by the wireless node is greater than a threshold value, and then delay an acquisition of a transmission opportunity based on the determination. For example, the wireless node may delay a start of a backoff time counter based on the determination, and/or may increase a value of the backoff time counter based on the determination. For example, the wireless node may delay an acquisition of a TXOP by using a access category (AC)-specific backoff timer value that includes a random value up to an AC-specific contention window plus an AC-specific relinquish backoff value

According to an example embodiment, a technique is provided for self-initiated relinquishing of a channel in a wireless network. A wireless node may, for example, delay a start of a backoff time counter by a delay period if a previous channel usage for the wireless node over a measurement period is greater than a threshold value.

According to another example embodiment, a method is provided that may include: making a determination, by a wireless node, that an amount of previous channel usage by the wireless node, e.g., over a measurement period, is greater than a threshold value, and delaying a start of a backoff time counter for the node based on the determination. In an example embodiment, the wireless node may delay a start of a backoff time counter by extending the arbitration inter-frame space (AIFS[AC]) for the node by a delay period, such as a relinquish inter-frame space (RIFS[AC]), if the previous channel usage for the node is greater than the threshold value. By delaying a start of a backoff time counter for a node by an additional delay (e.g., RIFS) when the previous channel usage for the node exceeds a threshold value over a measurement period, this may provide increased opportunity for other nodes to access the channel or win the transmission opportunity (TXOP). In such case, according to an example embodiment, the node may detect an idle channel for at least AIFS[AC] plus RIFS [AC] before starting its backoff time counter or before starting transmission (e.g., in case of zero backoff time value).

In another example embodiment, an apparatus may be provided for wireless communication by a node. The apparatus may determine whether an amount of previous channel usage by the node is greater than a threshold value. The wireless node may start transmission over the channel after detecting an idle channel for at least an arbitration inter-frame space (AIFS)[AC] if the previous channel usage by the node is not greater than the threshold value. This may include, for example, starting a backoff time counter for the node after detecting an idle channel for at least AIFS [AC], if the previous channel usage by the node is not greater than the threshold value. Also, the node may start transmission over the channel after detecting an idle channel for at least an arbitration inter-frame space (AIFS[AC]) plus an additional delay period if the previous channel usage by the node is greater than the threshold value. This may include starting transmission over the channel, or starting a backoff time counter after detecting an idle channel for at least AIFS[AC] plus a relinquish inter-frame space (RIFS[AC]) if the previous channel usage by the node is greater than the threshold value,

The details of one or more implementations are set forth in the accompanying drawings and the description below. Other features will be apparent from the description and drawings, and from the claims.

### BRIEF DESCRIPTION OF THE DRAWINGS

FIG. 1 is a block diagram illustrating a wireless network according to an example embodiment.

FIG. 2 is a timing diagram illustrating operation of a wireless node according to an example embodiment.

FIG. 3 is a flow chart illustrating operation of a wireless node according to an example embodiment.

FIG. 4 is a flow chart illustrating operation of a wireless node according to another example embodiment.

FIG. 5 is a flow chart illustrating operation of a wireless node according to yet another example embodiment.

FIG. 6 is a block diagram illustrating an apparatus that may be provided in a wireless node according to an example embodiment.

### DETAILED DESCRIPTION

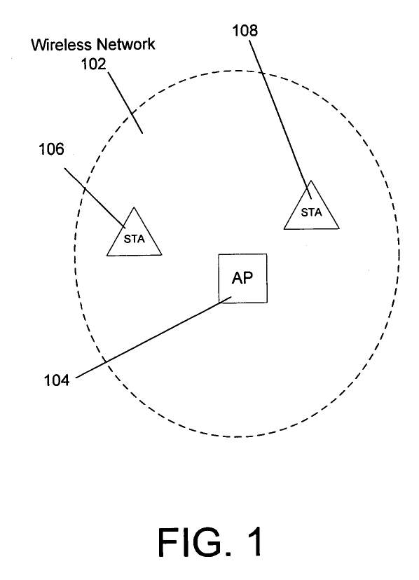

Referring to the Figures in which like numerals indicate like elements, FIG. 1 is a block diagram illustrating a wireless network according to an example embodiment. Wireless network 102 may include a number of wireless nodes or stations, such as an access point (AP) 104 or base station and one or more mobile stations or subscriber stations, such as stations 106 and 108. While only one AP and two mobile stations are shown in wireless network 102, any number of APs and stations may be provided. Each station in network 102 (e.g., stations 106, 108) may be in wireless communication with the AP 104, and may even be in direct communication with each other. Although not shown, AP 104 may be coupled to a fixed network, such as a Local Area Network (LAN), Wide Area Network (WAN), the Internet, etc., and may also be coupled to other wireless networks.

The various embodiments described herein may be applicable to a wide variety of networks and technologies, such as WLAN networks (e.g., IEEE 802.11 type networks), IEEE 802.16 WiMAX networks, WiMedia networks, Ultra Wide Band networks, cellular networks, radio networks, or other wireless networks. In another example embodiment, the various examples and embodiments may be applied, for example, to a mesh wireless network, where a plurality of mesh points (e.g., Access Points) may be coupled together via wired or wireless links. The various embodiments described herein may be applied to wireless networks, both in an infrastructure mode where an AP or base station may communicate with a station (e.g., communication occurs through APs), as well as an ad-hoc mode in which wireless stations may communicate directly via a peer-to-peer network, for example.

The term “wireless node” or “node,” or the like, may include, for example, a wireless station, such as a mobile station or subscriber station, an access point (AP) or base station, a relay station, a wireless personal digital assistant (PDA), a cell phone, an 802.11 WLAN phone, a WiMedia device, a WiMAX device, a wireless mesh point, or any other wireless device. These are merely a few examples of the wireless devices and technologies that may be used to implement the various embodiments described herein, and this disclosure is not limited thereto.

According to an example embodiment, a self-initiated relinquish mechanism may be provided. A wireless node, for example, may monitor its past usage of the channel or keep track of its previous channel usage, such as a percentage of previous channel usage over a specific measurement period or averaging time. If the node's amount of previous channel usage is greater than a threshold value, then the wireless node may delay a start of its backoff time counter by a delay period, described in this disclosure as a relinquish inter-frame space (RIFS), although the particular name for this additional delay period is not important since it may be implemented using different names in various technologies or standards. A different value for RIFS may be provided for each access category, for example.

In an example embodiment, the measurement period may be, for example, a predefined measurement period, or may be a measurement period based on an access category, such as a different measurement period for each access category. Likewise, in an example embodiment, the threshold value may be a predefined threshold value, or may be a threshold value based on an access category, such as a different threshold value for each access category. Also, the measurement period and threshold values may be measured in different units. For example, the measurement period and threshold values may be measured or provided in time, such as seconds, or timer units, or in bits or packets, such as a number of received bits or frames or packets, for example.

Thus, a wireless node may, for example, start its backoff time counter after detecting an idle channel for at least an arbitration inter-frame space (AIFS) if the node's previous channel usage is less than or equal to a threshold value. Otherwise, the wireless node may start its backoff time counter after AIFS plus RIFS if the node's previous channel usage is greater than the threshold value. In such a case, this may extend AIFS by a delay period RIFS before, for example, starting the decrementing of the node's backoff time counter in order to increase the likelihood that other wireless nodes will successfully contend for channel access or win the transmission opportunity (TXOP), according to an example embodiment. The use of the additional delay period, RIFS, may allow a node to effectively relinquish the channel to another node that may be attempting to access the channel, for example.

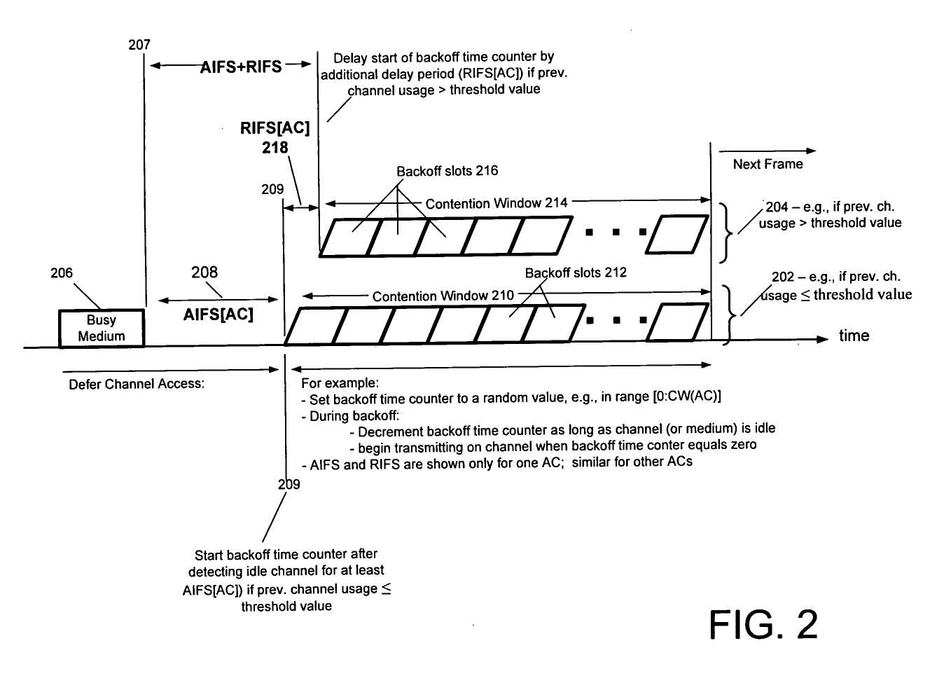

FIG. 2 is a timing diagram illustrating operation of a wireless node according to an example embodiment. According to an example embodiment, a wireless node may monitor its previous channel usage over a measurement period or averaging time, to determine its amount of previous channel usage over the measurement period, e.g., a total amount of time of usage or as a percentage of the measurement period. If the previous channel usage for the wireless node over the measurement period has exceeded a threshold value, such as 43.75% for example, the wireless node may delay its transmission or the start of its backoff time counter by an additional delay period described herein as relinquish inter-frame space (RIFS). The number 43.75% for the threshold value is merely an example, and any number may be used. By using the additional delay period or RIFS, this may in some cases increase the likelihood that another node will win or obtain the transmission opportunity.

Referring to FIG. 2, a lower portion 202 illustrates timing for a node having a previous channel usage that has not exceeded a threshold value. Upper portion 204 of FIG. 2 illustrates timing for a node having a previous channel usage that has exceeded the threshold value. In lower portion 202, a medium or channel is busy at 206. At 207, the channel is idle. The channel may be idle for at least an arbitration inter-frame space, or AIFS[AC] 208, up until point 209. A contention window 210 is shown, and may include one or more backoff slots 212. Similarly, in upper portion 204, the channel is busy at 206, and the channel becomes idle at point 207. A contention window 214 is provided beginning at point 213, and may include one or more backoff slots 216.

A wireless node with a packet to transmit may monitor the channel (medium). Initially, the channel may be busy at 206. However, at 207, the channel becomes idle. If the channel is idle for a period of time equal to an arbitration inter-frame space AIFS[AC], the wireless node may generate a backoff time to decrease the probability of collision. The backoff time may be selected, for example, as a random value in the range [0, CW], where CW identifies the contention window size. The backoff time may typically be an integer indicating a number of backoff slots, for example.

According to an example embodiment, CW may initially be set to CWmin or the minimum contention window size. Thus, depending on the CWmin, the backoff time may be set to zero, or some other value, for example. The backoff time counter may be set to this backoff time. The contention window and random backoff time counter may use a discrete scale, measured in backoff slots, for example. If an attempt to access a channel is unsuccessful due to collisions, then the node may increase the CW (e.g., up to CWmax), select a new random backoff time between [0, CW] for the backoff time counter, and then may re-attempt to access the channel. This process may be repeated, with CW increasing after each collision or unsuccessful attempt, for example.

The wireless node may then determine whether its previous channel usage has exceeded a threshold value. For example, the wireless node may determine whether its previous channel usage or amount of time transmitting data over a measurement period exceeds a threshold value. The threshold value may be provided per AC, or a different threshold value for each AC, and the threshold values may vary based on a number of users of a channel or other conditions.

If the previous channel usage for the wireless node, e.g., over the measurement period, is not greater than the threshold value, then the wireless node may use the timing as shown in lower portion 202 of FIG. 2, as an example. Referring to lower portion 202 of FIG. 2, because the previous channel usage for the node does not exceed the threshold value, the wireless node may start (e.g., start decrementing) its backoff time counter after detecting an idle channel for at least AIFS[AC] 208. According to an example embodiment, during this random backoff, a random backoff time counter is decremented so long as the channel is sensed idle, is frozen when a transmission is detected on the channel, and is restarted or continues decrementing when the channel is again sensed idle for a period of at least AIFS[AC]. The wireless node may then transmit over the channel when its backoff time counter reaches zero, for example. A node may transmit at the beginning of a backoff slot. The contention window size, CW, may be set to zero or some other value, as noted.

Therefore, in the case shown as lower portion 202, the wireless node may start transmission over the channel after detecting an idle channel for at least an AIFS[AC] if the previous channel usage for the node is not greater than the threshold value. There may be a random backoff period provided as well, e.g., zero or more slots, before transmission.

On the other hand, if the previous channel usage for the wireless node is greater than the threshold value, then the wireless node may use the timing as shown in upper portion 204 of FIG. 2, for example. Referring to the upper portion 204 of FIG. 2, because the previous channel usage for the node is greater than the threshold value, the wireless node may start (e.g., start decrementing) the backoff time counter after detecting an idle channel for at least AIFS[AC] 208 plus RIFS[AC] 218. The node may begin transmitting when its backoff time counter reaches zero. Thus, as compared to the case 202, in this case 204 the start of the backoff time counter is delayed by an additional delay, RIFS[AC] 218, e.g., to allow other nodes an improved opportunity to access the channel. Thus, in an example embodiment, the AIFS[AC] may be extended by RIFS[AC] if the previous channel usage for the node is greater than the threshold value.

According to an example embodiment, as shown in upper portion 204, the wireless node may start transmission over the channel after detecting an idle channel or medium for at least AIFS[AC] plus RIFS[AC] if the previous channel usage for the node is greater than the threshold value. There may be a random backoff period provided as well, e.g., zero or more slots, before transmission.

According to an example embodiment, a different RIFS[AC] may be provided for each AC. The RIFS may be a silent period, the length of which may enable other nodes with backoff counters of a same AC to access the channel, or to at least increase the probability that these other nodes will be able to access the channel. RIFS[AC] may be defined with the resolution of a clock or in steps such as backoff slots, etc.

There may be an efficiency penalty in some cases for the additional RIFS delay, especially in cases where the node adds the RIFS delay, but there is no other node attempting to use the channel, thereby introducing unnecessary delay. The efficiency penalty may be calculated or estimate as RIFS/Measurement period, for example. The measurement period may be decreased to allow relinquishment through additional RIFS delay to be performed more frequently. Thus, if there are a higher number of nodes competing for the channel or a significant number of collisions, for example, then the threshold value may be decreased, and/or the measurement period may be decreased, and/or the RIFS[AC] may be increased to better allow other stations to obtain access to the channel. According to an example embodiment, selecting a RIFS[AC] delay period that is shorter than a maximum wait time, such as CWmax, may decrease the likelihood of another node successfully obtaining the TXOP, but provides a lower efficiency cost or network delay in case other nodes are not trying to access the channel. The table below illustrates some example measurement periods (or averaging times), RIFS, and efficiency costs, for each of several different ACs. This table is merely an example, and other numbers may be used.

| | Measurement | RIFS_min | RIFS_max | Efficiency |
|---|---|---|---|---|
| AC | Period | (CWMin) | (CWMax) | cost (%) |
| BE | 100 ms | 135 us | 9207 us | 0.1-9.2 |
| BK | 100 ms | 135 us | 9207 us | 0.1-9.2 |
| VI | 20 ms | 63 us | 4599 us | 0.3-23.0 |
| VO | 10 ms | 27 us | 2295 us | 0.3-23.0 |

In the table above, the different access categories (ACs) may include, for example, BE (Best Effort), BK (Background), VI (Video) and VO (Voice). For example, VI and VO categories are a higher ACs (and thus higher priority) than the BE and BK categories. In the table above, the results, for example, may be calculated based on the input data to indicate the efficiency cost (or penalty) of using the RIFS [AC] for various access categories. As can be seen from the table, the efficiency cost or penalty is typically fairly small unless higher RIFS values are used near the RIFS-max.

As noted above, nodes may increase a contention window size after each collision or unsuccessful attempt to access a channel, for example. Similarly, according to another example embodiment, a node may increase RIFS[AC] after each unsuccessful attempt to relinquish the channel to another node. Once another node has obtained the TXOP, then RIFS[AC] may be reset to initial values, for example.

In an example embodiment, a wireless node may notify other nodes, e.g., by sending or broadcasting a message, that it intends to use RIFS during a next period of time. This may allow nodes to make decisions when to attempt to obtain channel access, or when to wake-up from a low power state and contend for the TXOP.

Another alternative embodiment will now be described. Starving nodes, or nodes that may have unsuccessfully attempted to obtain a TXOP, may typically consume significant power because they may sense the channel or medium regularly, although such nodes may not be able to transmit data. Thus, in an example embodiment, a node may generally remain in a low-power state, and then wait until after a beacon period has completed, or wait until after node reservations (such as for Distributed Reservation Protocol reservations) for transmission have completed, before waking from a low-power state and contending for channel access. Thus, in an example embodiment, such nodes waking and contending for a TXOP after a beacon period and/or reservation period may set their contention windows (CW) to CWmin, and/or set their random backoff time counters to zero or to low values based on a low or minimum CW, to improve the likelihood of obtaining channel access. Likewise, after the beacon period or reservation period, a wireless node having previous channel usage that is greater than a threshold may wait AIFS[AC] plus RIFS[AC] before transmitting, to increase the probability that another node will obtain the TXOP after the beacon period or reservation period.

In an example embodiment, use of the additional delay period, RIFS, may work well for lower priority traffic ACs, such as BE (best efforts) and BK. It may, in some cases, be less desirable to use RIFS for higher access categories, such as voice (VO) and video (VI) access categories, since these nodes may need to transmit a packet periodically, e.g., every 20 ms. However, this is just one example. The use of RIFS may be advantageously used for all ACs, or just some ACs, such as BE and BK, for example.

According to another embodiment, a wireless station or node that has used a channel resource more than a threshold amount may increase a value for its backoff time counter. For example, a wireless node that has exceeded a threshold usage value may increase a value of its backoff time counter by an AC (access category)-specific relinquish backoff value, Rbackoff[AC]. Thus, use of Rbackoff[AC] may provide a larger backoff timer value for those wireless nodes that have used the channel more than a threshold value, which may allow other wireless nodes better opportunity to obtain or acquire the transmission opportunity (TXOP).

For example, if a wireless node has a previous channel usage over an averaging or measurement period that does not exceed a threshold, then the node may use a standard backoff time counter value, which may be, for example:

Backoff[AC]=Rand(1 . . . CW[AC), if previous channel usage≦threshold. Thus, a value of the backoff time counter for the node may be a selected random value between 1 and an access-category specific contention window size. Contention window, and backoff time counter value may be measured, for example, as a number of discrete timer intervals or slots.

On the other hand, if the channel or medium usage over a measurement or averaging period for the node exceeds a threshold, then the backoff timer value for the node may be increased, e.g., beyond the standard backoff timer value, by an AC-specific relinquish backoff timer value, Rbackoff[AC].

Backoff[AC]=Rand(1 . . . CW[AC)+Rbackoff[AC], if previous channel usage>threshold. Thus, the backoff timer value may be increased in cases where a node's previous channel usage may have exceeded a threshold, for example.

The RIFS[AC], or relinquish inter-frame space to delay a start of a backoff time counter, and Rbackoff[AC] to increase a value of the backoff timer counter, may be used separately or together to delay a node's acquisition of a transmission opportunity (TXOP) or delay channel access.

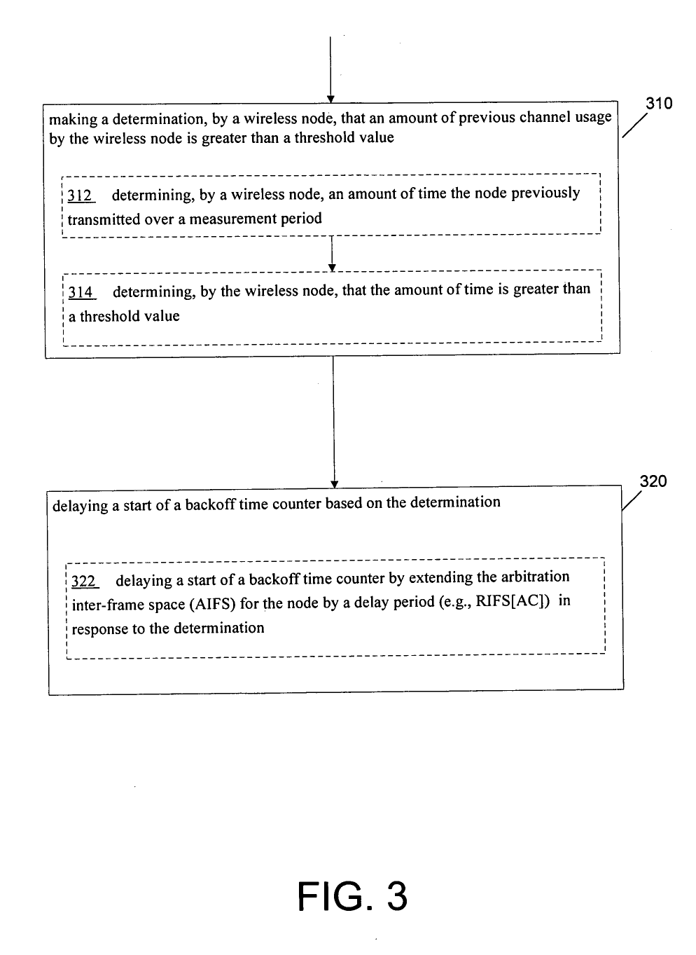

FIG. 3 is a flow chart illustrating operation of a wireless node according to an example embodiment. At 310, a wireless node may make a determination that an amount of its previous channel usage is greater than a threshold value. Operation 310, for example, may include determining an amount of previous channel usage by the node, and then determining that the amount of previous channel usage by the node is greater than the threshold value.

As another example of operation 310, a node may determine that an amount of time the node is transmitting, e.g., over a measurement period (312), and then determine that the amount of time is greater than a threshold value (314).

At 320, the node may delay a start of a backoff time counter (e.g., delay a start of decrementing the backoff time counter) based on the determination. For example, operation 320 may include delaying a start of a backoff time counter by extending the arbitration inter-frame space (AIFS) for the node by a delay period (e.g., RIFS[AC]) in response to the determination (322).

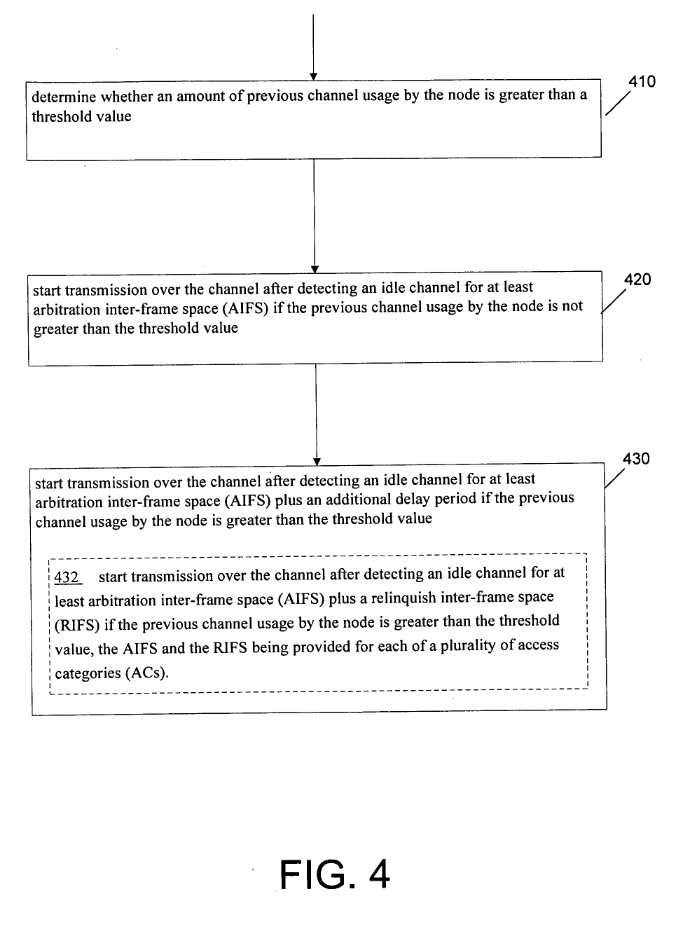

FIG. 4 is a flow chart illustrating operation of a wireless node according to another example embodiment. At 410, a wireless node may determine whether an amount of previous channel usage by the node is greater than a threshold value.

At 420, the wireless node may start transmission over the channel after detecting an idle channel for at least an arbitration inter-frame space (AIFS)[AC] if the previous channel usage by the node is not greater than the threshold value. Operation 420 may include, for example: determining an access category for the node, determining an AIFS associated with the access category, or AIFS[AC], and starting a backoff time counter for the node after detecting an idle channel for at least AIFS [AC], if the previous channel usage by the node is not greater than the threshold value. If, for example, the contention window or CW is set to a low value or zero, the backoff time counter may be set to a low value or even zero, thereby allowing the node to start transmitting over the channel immediately after detecting idle channel for AIFS[AC]. Of course, backoff time counter may be set to other, e.g., non-zero, values, which may increase the backoff delay after AIFS[AC] before the node may start transmitting over the channel, for example.

At 430, a node may start transmission over the channel after detecting an idle channel for at least an arbitration inter-frame space (AIFS) plus an additional delay period if the previous channel usage by the node is greater than the threshold value. Operation 430 may, for example, include starting transmission over the channel after detecting an idle channel for at least AIFS [AC] plus a relinquish inter-frame space (RIFS[AC]) if the previous channel usage by the node is greater than the threshold value. The AIFS and RIFS may be provided for each of a plurality if access categories. Operation 430 may include, for example: determining an access category for the node, determining an AIFS associated with the access category or AIFS[AC], determining a RIFS associated with the access category or RIFS[AC], and starting a backoff time counter after a period of AIFS[AC]+RIFS[AC], such as after detecting an idle channel for at least AIFS[AC]+RIFS[AC], for example, if the previous channel usage by the node is greater than the threshold value.

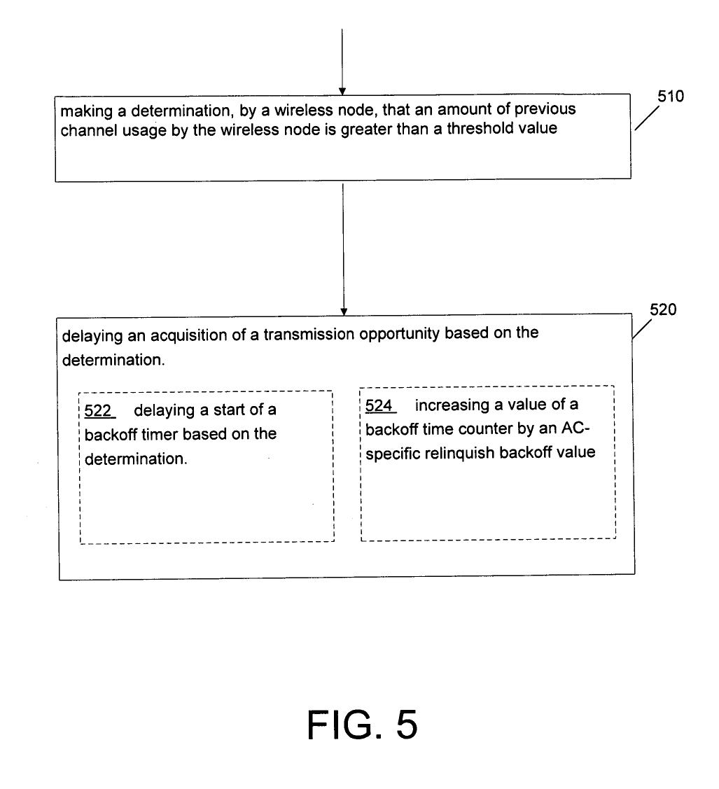

FIG. 5 is a flow chart illustrating operation of a wireless node according to another example embodiment. At 510, a determination is made, by a wireless node, that an amount of previous channel usage by the wireless node is greater than a threshold value. At 520, an acquisition of a transmission opportunity is delayed based on the determination. Operation 520 may include, for example, delaying a start of a backoff timer based on the determination (522) and/or increasing a value of a backoff time counter by an AC-specific relinquish backoff value (524).

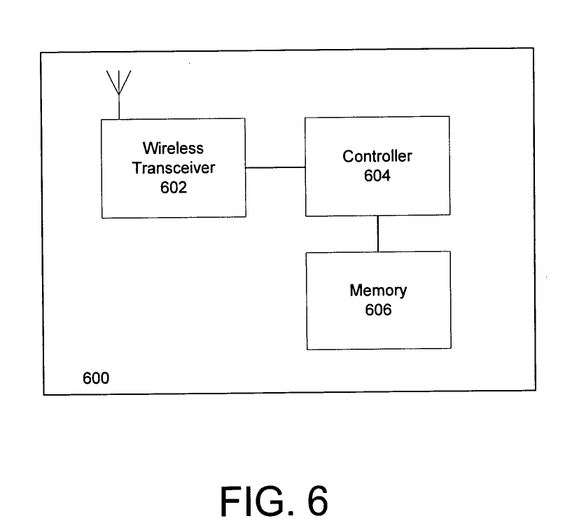

FIG. 6 is a block diagram illustrating an apparatus 600 that may be provided in a wireless node according to an example embodiment. The wireless node (e.g. station or AP) may include, for example, a wireless transceiver 602 to transmit and receive signals, a controller 604 to control operation of the station and execute instructions or software, and a memory 606 to store data and/or instructions.

Controller 604 may be programmable and capable of executing software or other instructions stored in memory or on other computer media to perform the various tasks and functions described above, such as one or more the tasks or methods described above in FIGS. 1-5. For example, the apparatus 600 may, through operation of controller 604 and other devices in apparatus 600, may make a determination that an amount of previous channel usage by the wireless node is greater than a threshold value, and then may delay an acquisition of a transmission opportunity based on the determination. For example, the wireless node may delay a start of a backoff time counter based on the determination, and/or may increase a value of the backoff time counter based on the determination. For example, the start of the backoff time counter may be delayed by a delay period, such as RIFS[AC] if the previous channel usage for the node is greater than a threshold value over a measurement period. This may provide, for example, that the node wait an idle channel period of at least AIFS plus RIFS before starting its backoff time counter or before transmitting (e.g., in a case of zero backoff), and therefore, may allow an increased opportunity for other nodes in the network to successfully contend for the channel. Also, the node, via controller 604, may increase a value of its backoff time counter by a value, such as Rbackoff[AC] to provide a greater or longer backoff for nodes that may have a previous channel usage that exceeds a threshold, for example.

In addition, a storage medium may be provided that includes stored instructions, when executed by a controller or processor that may result in the controller 604, or other controller or processor, performing one or more of the functions or tasks described above.

Implementations of the various techniques described herein may be implemented in digital electronic circuitry, or in computer hardware, firmware, software, or in combinations of them. Implementations may implemented as a computer program product, i.e., a computer program tangibly embodied in an information carrier, e.g., in a machine-readable storage device or in a propagated signal, for execution by, or to control the operation of, data processing apparatus, e.g., a programmable processor, a computer, or multiple computers. A computer program, such as the computer program(s) described above, can be written in any form of programming language, including compiled or interpreted languages, and can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps may be performed by one or more programmable processors executing a computer program to perform functions by operating on input data and generating output. Method steps also may be performed by, and an apparatus may be implemented as, special purpose logic circuitry, e.g., an FPGA (field programmable gate array) or an ASIC (application-specific integrated circuit).

While certain features of the described implementations have been illustrated as described herein, many modifications, substitutions, changes and equivalents will now occur to those skilled in the art. It is, therefore, to be understood that the appended claims are intended to cover all such modifications and changes as fall within the true spirit of the various embodiments.

What is claimed is:

1. A method comprising:
making a determination, by a wireless node, that an amount of previous channel usage by the wireless node is greater than a threshold value; and
delaying a start of a backoff time counter based on the determination.

2. The method of claim 1 wherein the making a determination comprises:
determining, by a wireless node, an amount of previous channel usage by the node; and
determining that the amount of previous channel usage is greater than a threshold value.

3. The method of claim 1 wherein the making a determination comprises:
determining, by a wireless node, an amount of time the node transmitted over a measurement time period; and
determining, by the wireless node, that the amount of time is greater than a threshold value.

4. The method of claim 1 wherein the threshold value comprises:
a predefined threshold value; or
a threshold value based on an access category (AC).

5. The method of claim 3 wherein the measurement time period comprises:
a predefined measurement time period; or
a measurement time period based on an access category (AC).

6. The method of claim 1 wherein the delaying comprises:
delaying a start of a backoff time counter by a delay period associated with an access category for the wireless node in response to the determination.

7. The method of claim 1 wherein the delaying comprises:
delaying a start of a backoff time counter by a relinquish inter-frame space (RIFS) associated with an access category for the wireless node in response to the determination.

8. The method of claim 1 wherein the delaying comprises:
delaying a start of a backoff time counter by extending the arbitration inter-frame space (AIFS) for the node by a delay period in response to the determination.

9. The method of claim 1 wherein the delaying comprises:
detecting an idle channel for at least an arbitration inter-frame space (AIFS);
delaying a start of a backoff time counter an additional delay period after the AIFS in response to the determination.

10. The method of claim 1 and further comprising determining an access category (AC) for the wireless node, and wherein the delaying comprises:
detecting an idle channel for at least an arbitration inter-frame space (AIFS) associated with the access category;
delaying a start of a backoff time counter an additional delay period associated with the access category after the AIFS in response to the determination.

11. The method of claim 1 and further comprising:
transmitting data over the channel after the backoff time counter reaches a predetermined value.

12. The method of claim 1 wherein the delaying comprises:
starting a backoff time counter after an arbitration inter-frame space (AIFS) plus an additional delay period after an end of a beacon period.

13. An apparatus provided in a wireless node, the apparatus adapted to:
determine whether an amount of previous channel usage by the node is greater than a threshold value; and
delay a start of a backoff time counter if the previous channel usage by the node is greater than the threshold.

14. The apparatus of claim 13 wherein the apparatus adapted to delay comprises an apparatus adapted to delay a start of a backoff time counter by a delay period associated with an access category for the wireless node if the previous channel usage by the node is greater than the threshold.

15. The apparatus of claim 13 wherein the apparatus adapted to delay comprises an apparatus adapted to:
determine an access category for the wireless node; and
if the access category for the wireless node is within a set of access categories, then the apparatus adapted to:
delay a start of a backoff time counter by a delay period associated with the determined access category for the wireless node if the previous channel usage by the node is greater than the threshold.

16. The apparatus of claim 13 wherein the apparatus adapted to delay comprises an apparatus adapted to delay a start of a backoff time counter by extending the arbitration inter-frame space (AIFS) for the node by a delay period if an amount of previous channel usage by the node is greater than a threshold value.

17. The apparatus of claim 13 wherein the apparatus adapted to delay comprises an apparatus adapted to:
start a backoff time counter after an arbitration inter-frame space (AIFS) plus an additional delay period after an end of a beacon period.

18. The apparatus of claim 13 wherein the apparatus is further adapted to start the backoff time counter after detecting an idle channel for an arbitration inter-frame space (AIFS) if an amount of previous channel usage by the node does not exceed a threshold value; and
wherein the apparatus adapted to delay includes the apparatus adapted to start the backoff time counter after detecting an idle channel for an arbitration inter-frame space (AIFS) plus an additional delay period if an amount of previous channel usage is greater than the threshold value.

19. An apparatus provided in a wireless node, the apparatus adapted to:
determine whether an amount of previous channel usage by the node is greater than a threshold value;
start transmission over the channel after detecting an idle channel for at least an arbitration inter-frame space (AIFS) if the previous channel usage by the node is not greater than the threshold value; and
start transmission over the channel after detecting an idle channel for at least arbitration inter-frame space (AIFS) plus an additional delay period if the previous channel usage by the node is greater than the threshold value.

20. The apparatus of claim 19 wherein the apparatus adapted to start transmission over the channel after detecting an idle channel for at least arbitration inter-frame space (AIFS) plus an additional delay period comprises the apparatus adapted to:
start transmission over the channel after detecting an idle channel for at least arbitration inter-frame space (AIFS) plus a relinquish inter-frame space (RIFS) if the previous channel usage by the node is greater than the threshold value, the AIFS and the RIFS being provided for each of a plurality of access categories (ACs).

21. The apparatus of claim 19, the apparatus further comprising:
a controller;
a memory coupled to the controller; and
a wireless transceiver coupled to the controller.

22. A method comprising:
making a determination, by a wireless node, that an amount of previous channel usage by the wireless node is greater than a threshold value; and
delaying an acquisition of a transmission opportunity based on the determination.

23. The method of claim 22 wherein the delaying comprises delaying a start of a backoff time counter based on the determination.

24. The method of claim 22 wherein the delaying comprises increasing a value of a backoff time counter based on the determination.

25. The method of claim 24 wherein the increasing comprises increasing a value of a backoff time counter by an AC-specific relinquish backoff value.

26. The method of claim 22 wherein the delaying comprises using a access category (AC)-specific backoff time counter value that includes a random value up to an AC-specific contention window size plus an AC-specific relinquish backoff value.

27. The method of claim 22 wherein the delaying comprises:
delaying a start of a backoff time counter based on the determination; and
increasing a value of the backoff time counter based on the determination.

28. An article comprising:
a storage medium;
said storage medium including stored thereon instructions that, when executed by a processor, result in:
making a determination, by a wireless node, that an amount of previous channel usage by the wireless node is greater than a threshold value; and
delaying an acquisition of a transmission opportunity based on the determination.

29. The article of claim 28 wherein the instructions resulting in delaying an acquisition of a transmission opportunity based on the determination comprise instructions that, when executed by a processor result in:
delaying a start of a backoff time counter based on the determination; or
increasing a value of a backoff time counter based on the determination.
